(19) United States
(12) Patent Application Publication
(10) Pub. No.: US 2013/0227874 A1
(43) Pub. Date: Sep. 5, 2013

(54) Fishing Lure

(71) Applicant: Clifton Dugan, Denison, TX (US)

(72) Inventor: Clifton Dugan, Denison, TX (US)

(21) Appl. No.: 13/411,377

(22) Filed: Mar. 2, 2012

(51) Int. Cl. A01K 85/00

(52) U.S. Cl. 43/26.2

(57) ABSTRACT

A fishing lure to generate a vibration and sound may include an exterior housing having a cavity, a motor and battery module positioned within the cavity and may or may not be connected to the exterior housing, a battery connected to the motor and not connected to the exterior housing to provide power for the motor and a off-center weight being connected to the motor and not connected to the exterior housing to produce the vibration and sound by the motor and battery module striking the interior surface of the exterior housing.

Entire device or portions thereof may also be removably placed inside or attached outside any hard lure body or soft plastic bait in common use by fishing industry when provisions for such attachment are premade.

### FIELD OF THE INVENTION

This invention is directed to the field of fishing lures, more particularly to a battery powered vibrating fishing lure.

### BACKGROUND OF THE INVENTION

The present invention relates to a unique fishing lure of the type to simulate live fish bait to attract fish to be caught. The purpose of any fishing lure is to attract a fish by mimicking a creature which is a part of the normal diet of the fish, such as a worm, amphibian, or smaller fish. Among the expedients taught by the prior art are arrangements for producing sounds and vibrations. For example, U.S. Pat. No. 2,552,730, to Miller, provides a leaf spring which vibrates when the fishing line is given a sudden jerk. Since the spring vibrates in the water, however, the vibrations are of only short duration and thus effective only if a fish is in the immediate vicinity of the lure at the instant the spring is put in motion. U.S. Pat. No. 2,909,863, to Rector et al., discloses a lure which produces a knocking or tapping sound, by means of a weight striking the walls of the hollow interior of the lure. The action of this lure depends upon movement of the lure through the water, and, consequently, results in an erratic tapping rather than uniform vibrations. A piezoelectric transducer powered by a transistorized oscillator circuit is utilized in the lure shown in U.S. Pat. No. 2,757,475, to Pankove.

Further, plug-type lures having internal eccentric, vibrating or buzzing means for producing noise and lure vibration are known in the art. Typical of these lures is the Eccentric Motion Fishing Lure described in U.S. Pat. No. 3,841,012, to Maled, which includes a lure characterized by a hollow body which is caused to vibrate by a rotor, motor and battery combination located inside the body cavity. The battery is wired to the motor and drives an eccentrically mounted weight on the motor output shaft, which weight rotates and strikes the inside cavity of the body to produce vibration, motion, and sound. Another similar lure of the plug design is the Sonic Fishing Lure described in U.S. Pat. No. 3,310,902, to Godby, which lure includes a vibrating coil and breaker point system which are energized by a battery and activated by a switch means operated by tension applied to the connecting line. Buzzing or vibrating of the internal coil and breaker point system is accomplished by pulling or jerking the line to slidably displace the switch with respect to the lure body, and thus complete the electrical circuit.

### SUMMARY

A fishing lure to generate a vibration and sound may include an exterior housing having a cavity, a motor and battery module positioned within the cavity and may or may not be connected to the exterior housing, a battery connected to the motor and not connected to the exterior housing to provide power for the motor and a off-center weight being connected to the motor and not connected to the exterior housing to produce the vibration and sound by the interior motor module striking the interior surface of the exterior housing.

The motor and battery may form a motor/battery module.

The exterior housing may include a first housing and a detachably connected second housing.

The first housing may include an eyelet.

The second housing may include an eyelet.

The first housing may be threadably connected to the second housing.

The second housing may include an O-ring.

The second housing may include a flexible washer.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates an exploded view of the fishing lure of the present invention;

FIG. 2 illustrates a front view of the fishing lure of the present invention;

FIG. 3 illustrates a back view of the fishing lure of the present invention;

FIG. 4 illustrates a cross-sectional view of the motor module of the present invention;

FIG. 5 illustrates an exploded view of the fishing lure of the present invention;

FIG. 6 illustrates a cross-sectional view of the fishing lure of the present invention;

FIG. 7 illustrates an exploded view of an alternate motor module of the present invention;

FIG. 8 illustrates a side view of a portion of the fishing lure of the present invention;

FIG. 9 illustrates an exploded view of a typical soft plastic bait in common use by fishing industry showing a portion of the fishing lure of the present invention inserted into premolded cavity inside lure body; and

FIG. 10 illustrates a side view of a portion of the fishing lure of the present invention inserted into flexible apparatus as one method for attachment to outside of body of common fishing lures in use by fishing industry.

### DETAILED DESCRIPTION

The present invention may employ simple construction with as few as 2 major pieces. The present invention may be easily made to produce fish attracting sounds and vibrations. The present invention may be used with or attached to most hard and soft (rigid and flexible) baits now in use in fishing industry. The present invention may be molded or decorated to resemble any fish attracting bait. The present invention may generate sounds and vibrations which may be easily changed during manufacture or in the field. The motor and battery may be easily replaced in the field. The motor and battery may be turned off or left out completely if no sound or vibration is desired in the lure of the present invention. The exterior housing 103 may also be replaced in field if not molded into place inside lure.

It is known that fish are able to both hear sounds and feel vibrations, and this ability is specie dependent; for example different species react differently to different frequencies of sound and vibration.

The present invention including the fishing lure 100 may be changed easily in the field to attract different specie by changing just the motor module or the complete device inside the fishing lure 100 with another having different frequency characteristics.

The present invention may be designed to interface to water and/or an auxiliary lure body in order to transfer sounds and vibrations into the water or the surrounding lure body to do same.

The fishing lure 100 may include 2 major independent containers of which one or both may be watertight or sealed independently.

The motor and battery may be a motor module which may include a motor and cover and which may include a battery module which may include a battery and cover and may be tethered internally to the exterior housing 103 or may not be tethered.

The battery and motor module may be positioned into the exterior housing 103 in an inactive state or left out entirely if no sound is desired. The fishing lure may be 2 principle pieces hereafter referred to as the exterior housing 103 and the inside devices which may be the motor and battery which may be a single piece or 2 separate devices.

The exterior housing 103 may be transmitting sounds and vibrations and may be either contained into an artificial bait or be attached directly or indirectly coupled to water and may be decorated or molded to resemble bait or such.

The motor and battery module may rattle freely at its own natural frequency within exterior housing 103, striking the interior surface of the exterior housing to produce sounds and vibrations which may be transmitted into the water and or thru lure body to water and may be enticing to fish.

The motor and battery may be activated by selecting the on position of a switch with electrical connections between motor, switch and battery if manufactured as one piece or by connecting such as by screwing two separate pieces together with electrical connection provisions. The battery and motor may be formed in separate pieces with or without the switch. The operation of the fishing lure 100 may include placing the active motor and battery (module) inside of exterior housing 103 and connecting for example by screwing on an end cap of exterior housing 103 to make a substantially water tight connection with a portion of the exterior housing 103 which may include threads. The exterior housing 103 may be positioned within a cavity of a fishing lure and may be attached to the fishing lure by a friction fit or other method of attachment, or the exterior housing 103 may be decorated or molded in order to resemble a lure shape in order to be used without an additional covering. The motor and battery module may vibrate freely without a connection to the exterior housing 103 or be tethered within a cavity of the exterior housing 103 by a flexible tether to produce sounds and vibrations which are transferred to water from container outer surface and or thru lure body if placed in such.

### Outer Container Module

Container module or exterior housing 103 may include a sealing cover 110 which may be positioned at one or both ends of the exterior housing 103, and the sealing cover 106 may be detachable and may include watertight seals such as o-rings or soft flat washers or other appropriate devices which may make the interior of the exterior housing 103 watertight and which may facilitate the removal and insertion of inner motor and battery module.

Container or exterior housing 103 may include one or more eyelets attached to facilitate connecting an external line to the exterior housing 103 or may facilitate attaching hooks and facilitate connection to the surrounding lure body material. One or more eyelets may or may not be inside container in order to tether the motor and or the motor and battery module to the container. The container or exterior housing 103 may be cylindrical in shape and may include inner walls which may be molded or machined. The exterior housing inside wall 103 may be four six, eight or other number of sidewalls and in order to achieve different shapes to produce different sounds or vibrations. The inside walls of the exterior housing 103 may be uniform from end to end or vary in shape or size from end to end. The outside shape of the exterior housing 103 may be cylindrical but may vary in shape to conform to desired bait shape.

Exterior housing 103 may also be molded into conventional or unconventional lure bodies.

The inside walls of the exterior housing 103 may conform or may not conform to a different shape from the external shape of the motor module for example, the walls of the exterior housing 103 may be cylindrical, and external shape of the motor module may be square or hex or vice versa.

The exterior housing 103 may be placed into a cavity or may be attached to a variety of soft or hard plastic baits, or the exterior housing 103 may be decorated to resemble any fish enticing bait as desired.

The exterior housing 103 may also be molded into a portion of the conventional or unconventional lure body with one end female threaded and the other half of lure body with male threads, and the other half of the desired bait may include waterproof devices such as o-rings or soft flat washers or equivalent devices. The exterior housing 103 may be molded as one half of a lure with other half being attached by threads and a device for being waterproof, and the motor module may be active inside the exterior housing 103 to create sounds and or vibrations and the exterior housing end cup 106 may be able to detachably connected and may be detached to replace or activate inner module. The exterior housing 103 may be formed from any material or dissimilar materials such as plastic, metal or other appropriate material.

### Motor and Battery Module

The motor may not be watertight because it may be protected by a watertight exterior housing, but the motor may be made water tight if desired.

The motor and battery module may be formed as a single integral piece or maybe formed into two or more pieces.

The motor and battery may be in two pieces with each piece being watertight or not, but the motor and battery may be screwed or snap fitted together with a device for both being watertight if desired and electrical connections between the motor and battery being provided.

An external cover for the motor and battery module may be made of any flexible or rigid material or dissimilar material but will typically be hard plastic or other appropriate material. The motor may be securely and permanently mounted to inside of motor module if two piece construction or motor and battery may be module if a one piece construction.

The motor may be a typical DC pager motor, cell phone motor used to produce vibrations in common use or other motor to drive the off-center weight 107.

The battery may be a typical button type battery, batteries common in use in a variety of electronic devices or other battery to drive the motor. The voltage may be varied to generate different sounds or different sounds may be generated by changing the type of battery. The battery values may be between 1 and 6 volts DC or other voltage ranges.

Electrical connections may be made between battery and motor if the battery and motor are not integral.

The motor and battery module may be replaceable in field with substantially exact replacement, or the motor and battery module may be replaced with a different size or shape motor and or battery module if a different sound is desired.

The motor and battery module may have an integral on/off switch if the motor and battery module has been manufactured as one piece or the motor may be manufactured as two independent waterproof pieces and fitted together with threads or snap turn fitting with electrical connections between motor and battery and waterproof provisions.

The motor/motor module may be replaceable as a unit or separate portions if manufactured as more than one portion, and the motor/motor module may be replaced with a same size replacement or different sized or shaped module if desired.

The exterior shape and size of motor and battery module can be changed to alter the generated sound and vibration.

The purpose of the motor and battery module is to shake or vibrate (not connected to the exterior housing 103 freely or tethered to exterior housing 103) against inside wall of exterior housing creating sounds and vibrations. The outer cover of the motor and battery module and the interior wall of the exterior housing 103 can be formed of different shapes and sizes to facilitate sounds desired.

The battery may include a removable hatch cover for battery replacement and may be waterproof.

The fishing lure 100 of the present invention operates in any position, up, down, sideways and operates at most fishing depths and operates to generate sound and vibrations. The exterior housing 103 may be operated directly into a lake or stream or other type of water or maybe covered with a lure body to disguise the exterior housing 103. The exterior housing 103 may emit audible sounds and or vibrations (simultaneously or individually) in order to attract fish to the fishing lure 100. Both the vibrations and audible sounds may be produced by the motor and battery module striking the internal surface of the exterior housing 103. The sounds and vibrations may be generated independently of the position of the exterior housing 103 or movement of any kind by the outer lure body.

The fishing lure 100 may require no electronics or circuit boards or external wires connected to the water to activate sound (other than the motor, battery and the off-center weight). The fishing lure 100 may be activated by turning on switch or optionally just connecting the battery to motor to activate the motor module within the exterior housing 103 and may continue to operate until the battery is depleted or removed from container and turned off.

Different fish react differently to different frequencies of vibration and sound. The present invention can control the frequency of vibration and sound by controlling the travel distance between the motor and battery module and the interior surface of the exterior housing 103 or the speed of the motor. As the speed increases, the frequency of vibration and sound increases and as the distance between the motor module outer surface and the interior surface of the exterior housing 103 decreases, the frequency of vibration and sound increases. As the size differential decreases between the two, the frequency increases as a result of the decrease of time required for the motor module to transverse the distance to strike the interior wall of the exterior housing 103. And of course as the size differential is increased, the travel time between walls is increased thereby decreasing the frequency. Frequency of the sound and vibrations is controlled by these sizes and the battery voltage applied to the motor and by shapes of the two.

The off-center weight 107 may cause the motor to shake and vibrate. The cause is of course that the offset weighted shaft or partial flywheel on the motor creates an unbalance when the motor is running thus shaking the whole motor module as the motor is hard mounted to the inside of it.

An advantage of the present invention is that fishing lure 100 may not be permanently attached to any one lure. The present invention may be used in one lure device and then removed from the device and placed into another lure device of same or different shape and design. Many different lure devices may have a hollow area into which the exterior housing 103 may be positioned. This advantage may place the fishing lure 100 in the class of a fishing device instead of a fishing lure, yet the fishing lure 100 may stand alone and operate as a stand alone fishing lure and may be decorated. The fishing lure 100 of the present invention may not require balancing. Sound and vibration production may be substantially independent of lure balance, lure movement or stoppage in water. The fishing lure 100 of the present invention may be independent of path of the fishing lure 100 or the attitude of the fishing lure with respect to the bottom of the water while being retrieved or resting in water.

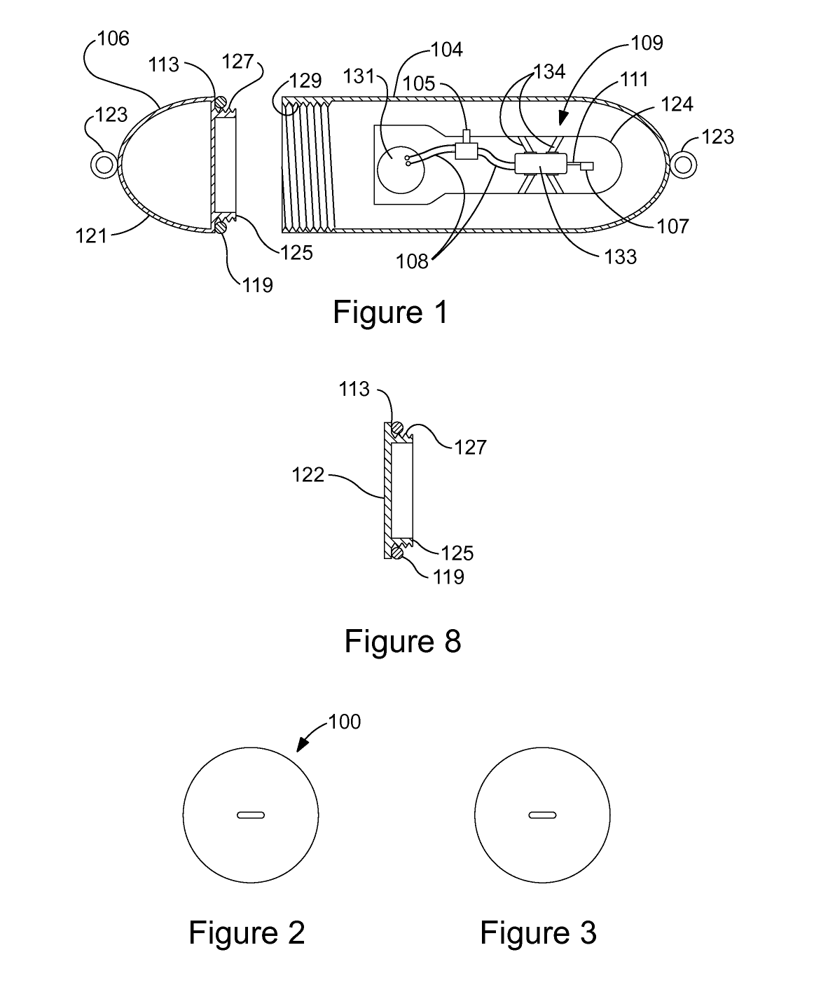

FIG. 1 illustrates an exploded view of the fishing lure 100 of the present invention and illustrates that the fishing lure 100 may include an external housing 103 which may include a first housing 104 (depictes the end) and a second housing 106 which may be detachably connected to the first housing 104. The second housing 106 may be a cover which may be threadably and detachably connected to the first housing 104. The second housing 106 may include a dome end 121, an eye let 123 for attachment to a fishing line or hook (not shown), a threaded cylinder 125 to connect to the dome end 121 at a shoulder 113, and a seal 119 to seal the second housing 106 to the first housing 104 by providing a water tight connection and may be a flexible O-ring or flexible washer.

The cylinder 125 may include male threads 127 to cooperate with female threads 129 of the first housing 104.

The first housing 104 may include a cavity 109 for the motor and battery module 124 which may include a battery 131 in order to supply power to a DC motor 133 which may turn a motor shaft 111 which may include a off-center weight 107 to produce the sound and vibration as the off-center weight shakes the entire motor and battery module which in turn strikes the interior wall of the first housing 104. As described above, the inside wall of the first housing 104 (interior wall) may be shaped as a cylinder, hex shape or other appropriate shape. The opposing end of the first housing 104 may include an eyelet 123. The motor may be hard mounted 134 to the interior wall of motor and battery housing 124. Motor 133 may be connected to battery 131 by wires 108 and passing through switch 105 which turns motor and battery module 124 on or off.

FIG. 8 illustrates an alternate cylinder end 122, a cylinder 125 to connect to the cylinder end 122 at a shoulder 113, and a seal 119 to seal the second housing 106 to the first housing 104 by providing a water tight connection and may be a flexible O-ring or flexible washer. The cylinder 125 may include male threads 127 to cooperate with female threads 129 of the first housing 104.

FIG. 2 illustrates a front view of the fishing lure 100 of the present invention.

FIG. 3 illustrates a back view of the fishing lure 100 of the present invention.

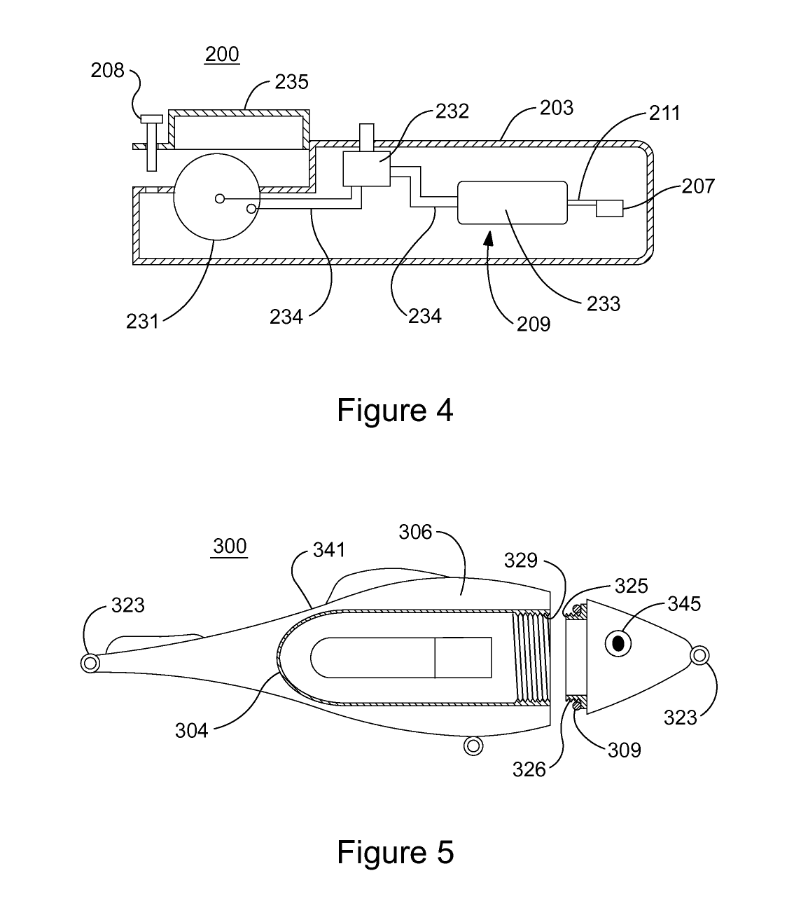

FIG. 4 illustrates a motor module 200 of the present invention and illustrates an exterior housing 203 which may include a sealing cover 235 which may waterproof and seals the exterior housing 203. The sealing cover 235 may be detachably connected to the exterior housing 203 and may be removed and fastened to the exterior housing 203 by a fastener 208. The exterior housing 203 may define a cavity 209 which may house the battery 231, the DC motor 233 which may be connected to the battery 231 by a switch 232 to connect and disconnect the motor 233 from a source of electricity in the battery 231. The portion of the switch 232 may extend through the exterior housing 203 in order for the user to connect and disconnect the motor 233 from the battery 231. The switch 232 may be connected to the motor 233 and to the battery 231 by wires 234. The motor 233 may include an extended shaft 211 which spins off center weight 207 and causes motor and battery module 200 to shake and vibrate.

FIG. 5 illustrates a fishing lure 300 which may include an outer body 341 which may include a first portion 343 which may be formed and decorated in the shape of a fish and a second portion 345 which may be formed and decorated in the shape of a fish. The first portion 343 may include an eyelet 323 to attach a fishing line and/ or hooks, and the second portion 345 may also include an eyelet 323 to attach a fishing line and/or hooks.

The second portion 345 may include a cylinder 325 which may include male threads 326 to connect to female threads 329 of the first portion 343 to connect the first portion 343 to the second portion 345. The second portion may additionally include a seal 309 which may be an O-ring or flexible washer to seal the first portion 343 to the second portion 345 containment cavity 304 may be molded into outer body 341 in order for motor and battery module 306 to strike its inside wall and produce sounds and vibrations.

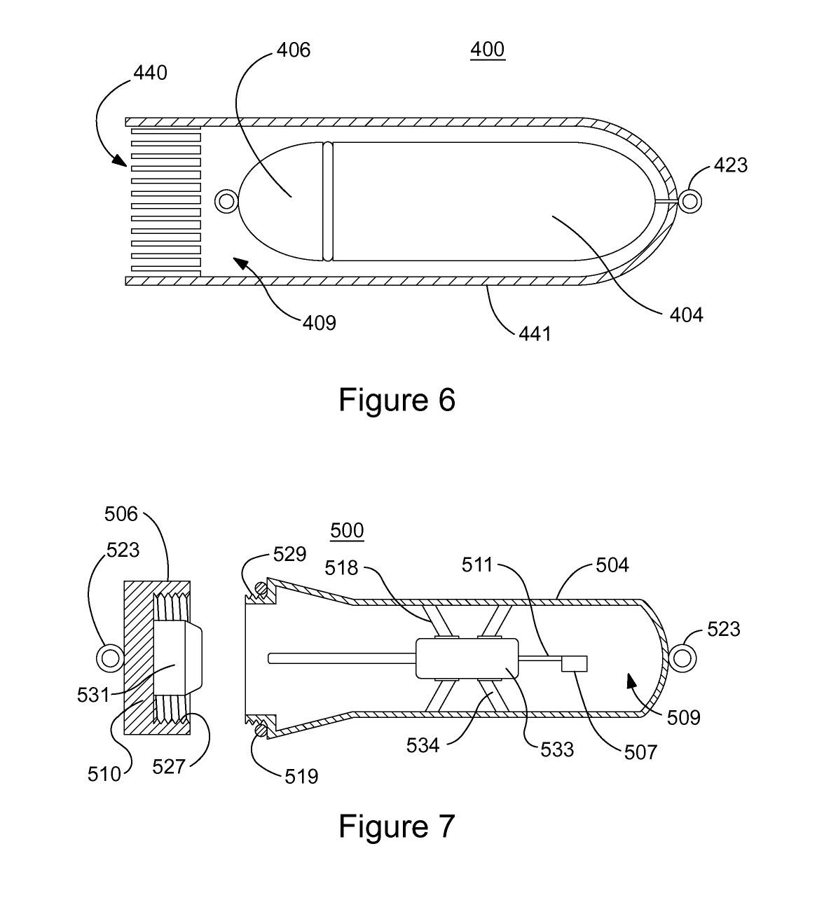

FIG. 6 illustrates a fishing lure 400 which may include an outer body 441 which may be formed and decorated in the shape of a fish or other aquatic entity and the outer body 441 may or may not include an eyelet 423 to attach a fishing line and/or hook. The outer body 441 may include a cavity 409 to position the exterior housing 403 which may include the first housing 404 which may include the motor and battery (not shown) and the second housing 406. The outer body 441 may include serrated decorated fringe 440 or other shape or decoration, and the outer body 441 maybe formed from flexible plastic lure body material eyelet 423 may also extend through body 441 and be connected to first housing 404.

FIG. 7 illustrates another motor and battery module 500 of the present invention and illustrates a exterior housing 503 which may include a first housing 504 and a second housing 506 which may be detachably connected to the first housing 504. The second housing 506 may be a cover which may be threadably and detachably connected to the first housing 504. The exterior housing 503 may define a first cavity 509 which may house the DC motor 533 which may be connected to the battery 531 which may be housed in a second cavity 510 of the second housing 506 by a male threaded connection 529 to female 527 thread in second housing 506 and may have means for electrical connection provisions. Motor 533 may be hard mounted 518 to inside of outer cover 504. When made active by screwing two halves together (504 and 506) to motor 533, motor 533 may spin extended shaft 511 and off center weight 507 which makes module 503 shake and vibrate. When placed inside device container 103 (as noted in FIG. 1), the alternate motor and battery module in active state will shake and vibrate freely within container housing 103 striking inside walls of housing 104 causing sound and vibrations to occur.

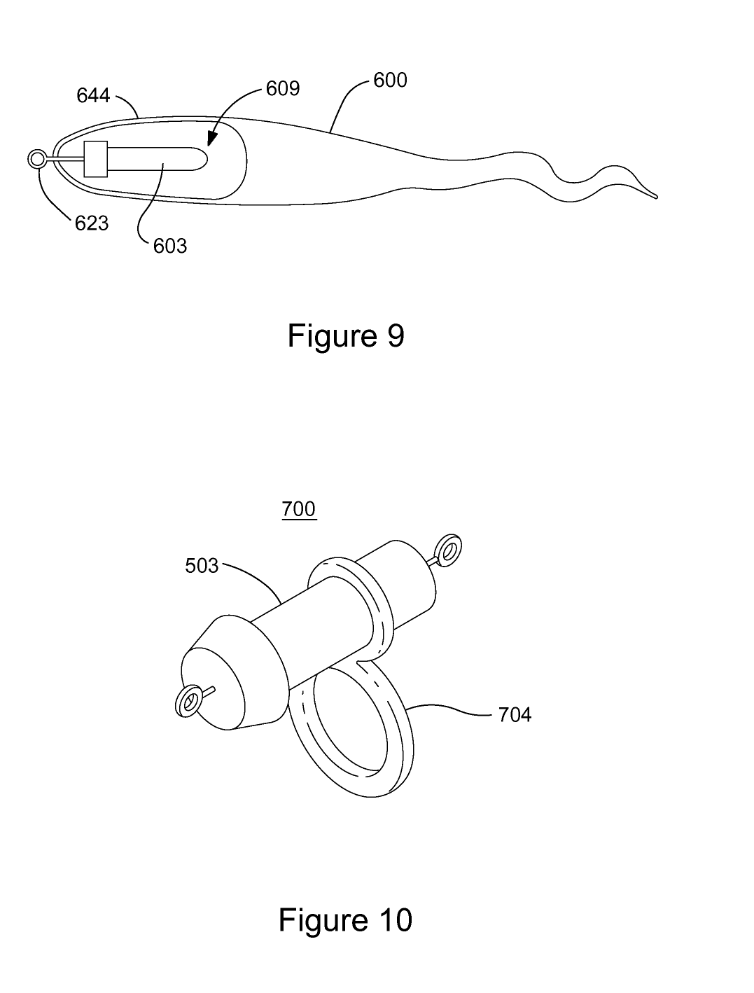

FIG. 9 illustrates how module 503 may also be used alone without external container 103 if no sound is desired but vibrations are desired. Module 503 may be placed into molded cavity 609 (FIG. 9) of soft plastic baits such as a worm or other aquatic replica as in common use in fishing industry 600. When used in this manor, module 503 (603 in FIG. 9) may have eyelet 623 attached to either and/or both ends for hook or line attachments. When used to produce sound and vibration as depicted in FIG. 1, eyelets may or may not be used. When module 503 used in manor depicted in FIG. 9, one or more eyelets may project through plastic bait body 644 for purpose of attaching hook or line or both.

FIG. 10 illustrates an apparatus for attaching alternate motor module 503 to outside of soft plastic bait such as depicted in FIG. 9 element 600 with a soft flexible material double ring arrangement 704 and not outer containment module when only vibrations and no sound is desired. Durable but flexible material may be molded smaller than module parts to cause a tight fit between parts.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A fishing lure to generate a vibration and sound, comprising:
an exterior housing having a cavity;
a motor and battery module positioned within the cavity and may or may not be connected to the exterior housing;
a battery connected to the motor and not connected to the exterior housing to provide power for the motor;
a off-center weight being connected to the motor and connected to the exterior housing to produce the vibration and sound by the motor and battery module striking the interior surface of the exterior housing.

2) A fishing lure to generate a vibration and sound as in claim 1, wherein the motor and battery form a motor/battery module.

3) A fishing lure to generate a vibration and sound as in claim 1, wherein the exterior housing includes a first housing and a detachably connected second housing.

4) A fishing lure to generate a vibration and sound as in claim 3, wherein the first housing includes an eyelet.

5) A fishing lure to generate a vibration and sound as in claim 3, wherein the second housing may or may not include an eyelet.

6) A fishing lure to generate a vibration and sound as in claim 3, wherein the first housing is threadably connected to the second housing.

7) A fishing lure to generate a vibration and sound as in claim 3, wherein the second housing includes an O-ring.

8) A fishing lure to generate a vibration and sound as in claim 3, wherein the second housing includes a flexible washer.

9) A fishing lure to generate vibration with little or no sound produced, comprising:
a premolded cavity to soft plastic bait;
a motor and battery module having no outer container module being placed into premolded cavity to soft plastic, wherein the motor and battery module is mounted in any orientation within or outside of lure body.

10) A fishing lure to generate vibration and sound comprising an outer container and inner motor and battery module as in claim 1, disposed within premade cavity or removably connected to any hard lure body or soft plastic bait (as in common use in fishing industry) in such manor to transmit vibrations and sound through lure body into water.
